(19) United States
(12) Patent Application Publication
(10) Pub. No.: US 2005/0025954 A1
(43) Pub. Date: Feb. 3, 2005

(54) Cloth backing for use in a trim cover

(76) Inventors: Alfred Hardy Sullivan JR., Hillsborough, NC (US); Monika MacManus Moore, Roxboro, NC (US); Ghanshyam J. Amin, Durham, NC (US); Patrick Earl Hawks, Mebane, NC (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/629,979

(22) Filed: Jul. 30, 2003

(51) Int. Cl. D03D 15/00; D03D 25/00; B32B 3/26; B32B 3/06; B32B 3/00; B32B 7/12; B32B 27/00

(52) U.S. Cl. 428/304.4; 428/315.9; 428/314.8; 428/317.5; 428/307.3; 428/319.7; 428/319.9

(57) ABSTRACT

A trim cover comprising a cloth including a backing layer, wherein the backing layer is a formed from a polyurethane dispersion. In method form the present invention relates to a method for forming a trim cover comprising supplying a cloth and applying a polyurethane dispersion as a backing layer to the cloth, wherein the polyurethane backing layer is applied and adhered to the cloth without the use of adhesives or flame lamination. Such trim covers are useful for preparing a trim panel including a supporting substrate.

### FIELD OF INVENTION

This invention relates to textiles such as woven or knitted cloth, or fabric, used as upholstery and, more particularly, to a foam backing which may be applied to the backside of the textile to provide process efficiencies as well as improved acoustical properties.

### BACKGROUND OF INVENTION

Textile materials such as woven or knitted cloth are widely used as a cover layer to provide both aesthetics and comfort to surfaces where humans may interface, such as the interior of vehicles, home environments, office settings, etc. Typically, the cloth layer covers a soft pliable layer of foam, such as a low density flexible polyurethane, to provide comfort upon contact.

Current practice in the industry requires that a relatively impermeable acrylic latex coating be applied to the backside of the cloth or fabric. This acrylic latex coating serves a number of purposes depending on the downstream processing of the cloth. In many applications, the coated cloth is laminated to a soft polyurethane foam layer using well-known methods of flame or adhesive treatment to insure adhesion. The laminated sheetstock thus prepared may then be cut into pieces and these pieces may be sewn together to form a trim cover for a seat cushion, seat back or other upholstery or trim panel. This “cut and sew” method provides an outer shape defining a bag-like enclosure which can be slipped over a polyurethane foam bun to form the finished cushion, etc. An alternate method uses the laminated cloth, particularly a knitted version, applied directly to a mold and shaped by vacuum or by the subsequent injection of liquid foam precursors on the foam layer. Variations of this “pour-in-place” process are disclosed in U.S. Pat. Nos. 4,806,088; 4,046,611 and 4,637,689. The expansion of the urethane foam precursors creates the foam bun “in-situ” while urging the backed cover layer to conform to the shape of the mold as well. Here, the urethane foam backing layer prevents strike-through, or penetration, of the liquid reacting foam through the cloth or fabric layer and, in addition, provides adhesion of the foam to the cover layer. In many applications, a separate barrier film may be applied to the exposed side of the foam layer to assure that strike-through does not occur.

Applications for these types of constructions are manifold; seat cushions, seat backs and armrests for home, office and travel environs as well as trim panels that may not interface regularly with an occupant (headliners, door panels, instrument panels, parcel shelves, etc. in transportation vehicles). In some of the latter examples, acoustic performance may be equally as important as aesthetics or comfort, and the use of an impermeable layer, such as the acrylic latex backing, provides less than desired performance in attenuating noise. Noise levels in the interior of a vehicle are directly equated to perceived quality and acoustics is becoming another way for carmakers to differentiate their product. Further, the latex backing applied to the backside of a cloth layer detracts from the feel or “hand” of the trim cover by adding stiffness to the cloth making it feel boardy.

Polyurethane dispersions (PUD) are known and can be useful for preparing polyurethane polymers that can themselves be useful in various applications, such as carpet backing. Typically, a polyurethane dispersion can be prepared by polymerization, in an organic solvent, of reactants, such as polyols and isocyanates, for example, followed by the dispersion of the resultant solution in water and optionally followed by the removal of the organic solvent. The resultant dispersion of polyurethane polymer in water may then be applied to the back of a carpet, in a frothed or unfrothed condition and the water evaporated to form a carpet backing. U.S. Pat. No. 6,271,276 and United States Patent Application Publication No. 2002/0197443, both assigned to the Dow Chemical Company, describes polyurethane dispersions for use in this manner.

What is needed is a single layer of somewhat permeable material that can be applied directly to the backside of a cloth or fabric textile and which forms a soft foam layer, thereby eliminating the need for the preparation of and lamination of an adhesive or flame-treated skived foam layer onto the backside of a cloth or fabric.

It is thus an object of this invention to provide a foam-backed cloth or fabric by applying a polyurethane dispersion directly onto the backside of the cloth or fabric.

It is a further object of the present invention to provide a backing applied to a cloth or fabric wherein the backing when applied does not strike-through or fully penetrate the cloth and does not allow subsequent downstream processes (foam-in-place, injection molding behind, etc.) to strike-through the cloth layer.

It is a still further object of the present invention to provide an improvement in the acoustical performance of the trim cover by providing a foam backing which may attenuate sound waves which pass through it.

It is still a further object of the present invention to provide a trim cover comprising a cloth or fabric outer layer backed with a foam layer formed from a polyurethane dispersion which provides improvements in downstream seat assembly, such as a reduced propensity to form wrinkles, a reduced need to apply steam to the finished seat cover to provide a taut fit of the trim cover to the foam bun and reduced assembly costs.

It is a still further object of the present invention to provide a cloth or fabric cover for various applications in a vehicle (instrument panel, door panel, headliner, parcel shelf, etc.) which can be foamed-in-place or injection molded behind.

It is still a further object of the present invention to provide a cloth or fabric cover for seating which provides improved breathability to the finished seat cushion.

### SUMMARY OF THE INVENTION

In a first embodiment, the present invention is directed at the application of a polyurethane dispersion (PUD) onto the backside of a cloth or fabric textile to form a semi-permeable soft cloth trim cover. As used herein, the term cloth or fabric textile includes any porous fabric or cloth that can be employed as a covering. The cloth or fabric textile can be made of synthetic or natural fibers or a blend thereof. The cloth or fabric textile cover may woven or a knit and may be comprised of a single sheet of material or may be prepared by attaching several pieces of cloth or fabric together, for instances, by sewing.

The foam-backed cloth obtained by applying the PUD to the backside of the cloth is useful as a cover layer or trim cover for various upholstery applications which may make use of “cut-and-sew”, “foam-in-place”, “vacuum form” and “shoot-behind” (injection molding) downstream processing techniques. By backing the cloth with a PUD, numerous efficiencies may be realized in processing, cost and product performance.

In method form, the present invention relates to a trim cover comprising a cloth containing a polyurethane backing layer, wherein said polyurethane backing layer is applied and adhered to the cloth without the use of adhesives or flame lamination.

### BRIEF DESCRIPTIONS OF THE INVENTION

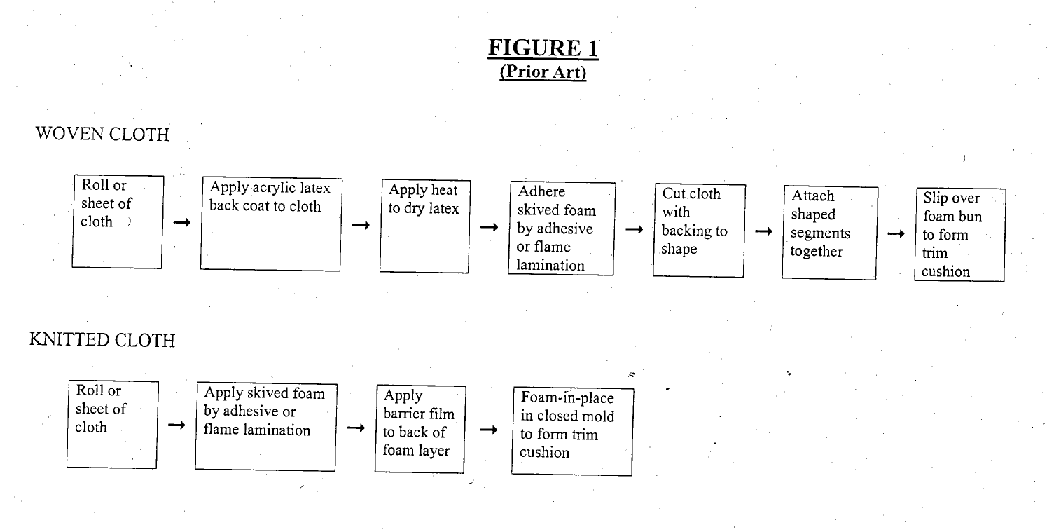

FIG. 1 is a block diagram describing the prior art.

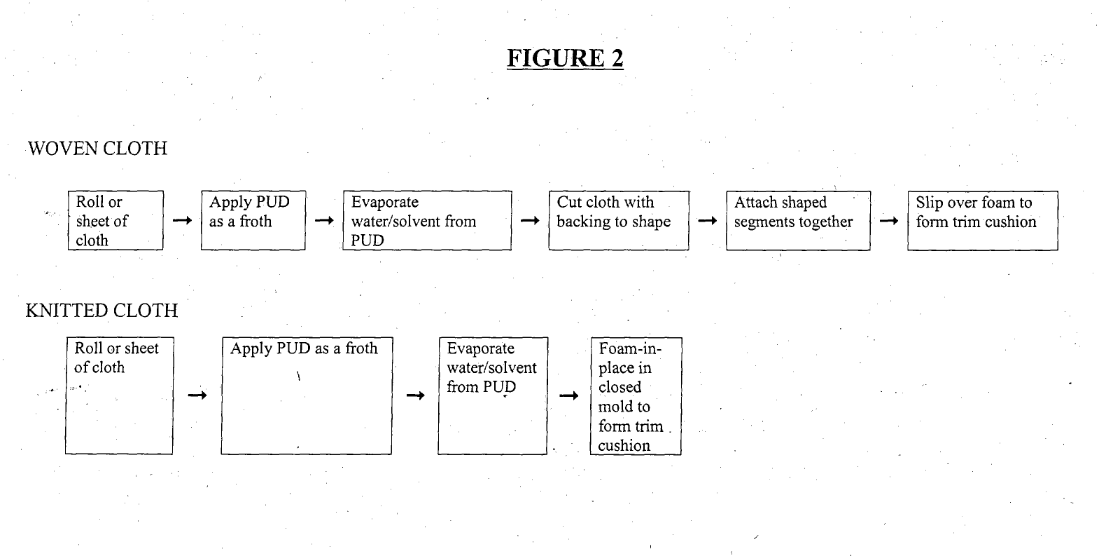

FIG. 2 is a block diagram describing the process of the present invention of backing a cloth with a PUD.

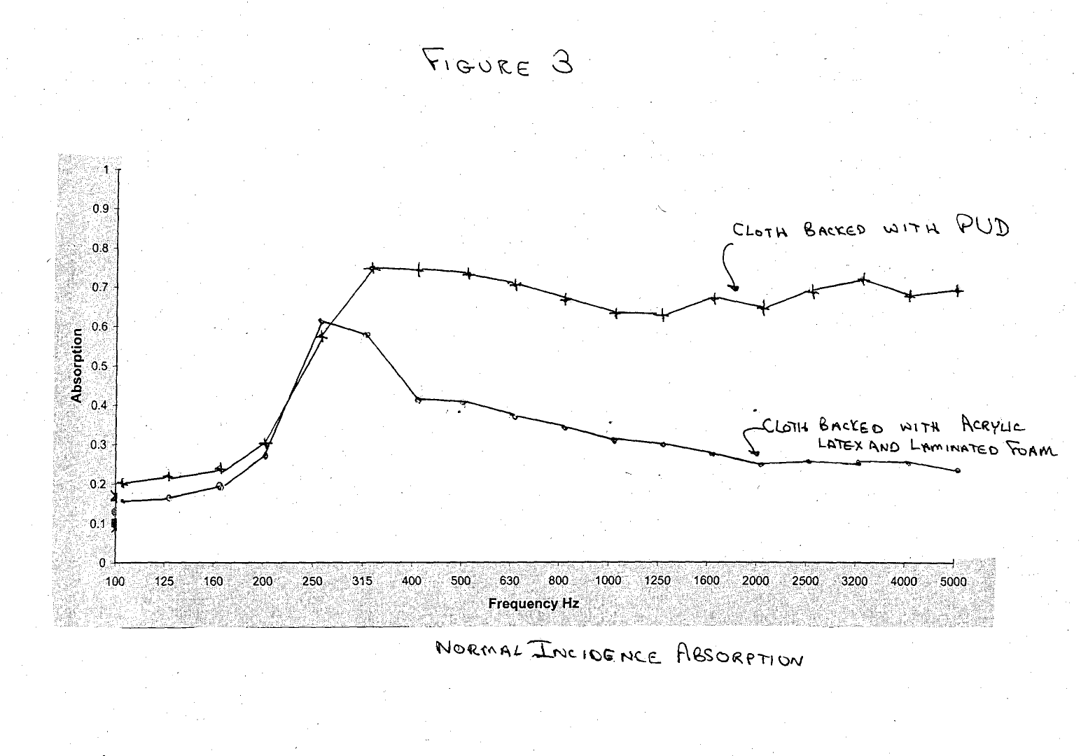

FIG. 3 is a graph of the sound absorption performance of the present invention.

### DETAILED DESCRIPTION OF THE PREFERRED EMBODIMENTS

As noted above, the present invention is directed at the use of a polyurethane dispersion (PUD) as a coating for the backside of a cloth or fabric layer, the cloth or fabric being used as an outer layer or trim cover in an upholstery application. The application of this technology may be directed in any of a variety of fields where there is a human interface to provide comfort, aesthetics or noise reduction, particularly in the home, office or transportation environments. Trim panels for furniture as well as vehicle applications may have a cloth outer layer and a foam backing, however, current practice requires the use of a relatively impermeable coating on the backside of the cloth to which a foam backing is adhered.

In the context of the present invention, the woven or knitted cloth as applied for a trim cover may have a basis weight of between about 100 to 950 grams/square meter (4.5 oz. per yard to 40 oz. per yard).

As shown in FIG. 1, a traditional process for preparing a trim panel, e.g. a seat cushion or seat back, begins with a roll of cloth or fabric prepared by weaving synthetic or natural fibers or yarn in a manner well-known to those skilled in the art. Blends of synthetic and natural fibers may also be used. The resultant cloth may be supplied as roll or sheet goods to a coating device where, typically, an acrylic latex coating may be applied to the backside of the cloth to seal the surface and provide dimensional stability as well as preventing ravel and pile loss. Subsequently, the coating is heated via an oven or alternate means to evaporate any water or solvents present, leaving a relatively impermeable backing layer on the backside of the cloth. The roll or sheet cloth goods having the backing layer of acrylic latex are then adhered to a thin layer of low density polyurethane foam using an adhesive or a flame lamination process. The thin layer of polyurethane foam is provided by pouring liquid precursors onto a conveyor to form a large bun. The bun is skived to thickness (about 3.2 mm or 0.125″) and the thin foam layer rolled up and delivered to the site for lamination. The cover material may be used in a cut-and-sew process to produce seat cushions or like trim panels.

In the case of the cut-and-sew process, the cloth is cut into pieces and these pieces sewn together to form a “bag-like” enclosure or slip cover into which a precut or premolded bun of foam can be inserted. In some instances, an adhesive web is applied to the back of the cloth over the laminated foam backing to ensure adhesion of the trim cover to the foam bun. Often it is necessary to subject the trimmed cushion to a steam treatment to eliminate wrinkles in the trim cover and provide a taut cover layer and also to activate the adhesive web layer.

An alternate process as also shown in FIG. 1, involves a cloth or fabric produced by the knitting process (as opposed to weaving), wherein the cloth has greater extensibility and pliability. Here, the knitted cloth is laminated to a low density polyurethane foam skived layer (produced as described above) by flame or adhesive processes known to those skilled in the art. The resultant sheet or roll goods may then be supplied to a foaming mold and positioned over the mold cavity. In most cases, a barrier film may be required to be applied to the backside of the foam layer to prevent strike-through in downstream processing. The cloth is formed to the shape of the mold cavity using one or a combination of pressure, vacuum or the expansion of foam precursors to produce a foamed article. Foam ingredients are poured or injected into the foam mold cavity onto the backside of the laminated knit cloth, and upon expansion, help to shape the cloth to the mold. This process provides some efficiencies as there is no need to cut and sew together sections of the laminated knit cloth to form the outer shape of the trim cover. However, the process is somewhat limited in the complexity of shapes which may be formed by the knit cloth, somewhat due to the skived polyurethane foam backing which may restrict the extensibility of the cloth. Newer applications of cloth-covered panels are presently being proposed for instrument panels on motor vehicles to differentiate the appearance of the vehicle interior. See pending U.S. application Ser. No. 10/373,332, entitled “Pre-Weakening of Fabric Covered Air Bag Door” commonly assigned to the assignee of the present invention and included herein by reference. The use of cloth trim covers on instrument panels will involve more complex and thinner shapes than seat cushions, making extensibility and prevention of strike-through even more important.

As shown diagramatically in FIG. 2, the present invention is directed at a simpler, more streamlined one-step process which, among other things, eliminates the need for the lamination of a foam layer to the backside of a cloth, by replacing the acrylic latex coating and laminated foam with a polyurethane dispersion. Polyurethane dispersions (PUD) are generally created by reacting polyols, such as polyethers or polyesters, and an isocyanate, such as methylene diphenyl diisocyanate (MDI), to form solvent free, high solids dispersions having submicron-sized particles and excellent stability. U.S. Pat. No. 6,271,276 describes formulations of the type useful in this invention which may include the use of copolymer polyols, polyamines, catalysts, foam stabilizers, fillers, thickeners, surfactants, frothing agents, dispersants, fire retardants, pigments, etc.

The process for backing a cloth or fabric with a polyurethane dispersion will now be described. In the present invention, roll or sheet goods of woven or knitted cloth are provided to an apparatus for back coating. A polyurethane dispersion of the type described above is provided to a mechanical device for frothing. Frothing involves the mechanical introduction of a gas, typically air, into the PUD to form a dispersion of fine air bubbles using such equipment as an Oakes or Firestone frother. The frother provides a stable froth which may be dispersed onto the backside of the cloth and the cloth drawn under a doctor blade, knife or other device to apply a smooth gauged layer of frothed dispersion (foam) onto the cloth. Alternate means of distributing and gauging the froth into a uniform layer on the backside of the cloth may also be used (knife-over-roll, extruder, spraying, etc.). The polyurethane dispersion typically is supplied at a solids percentage of about 30% to 70%, and at all incremental 1.0% levels therebetween. The frothing process generally yields a density for the cured foam layer of about 0.016-0.32 grams/cubic centimeter (1 to 20 pounds per cubic foot), preferably 0.032-0.08 grams/cubic centimeter (2-5 pounds per cubic foot). It has been found that the preferred range of thickness for applications of the type described in this invention is from 0.26-51.3 mm (0.010 to 2.0 inches), more preferably 2.6-6.5 mm (0.100 to 0.250 inches), but much thicker layers may also be used if desired. Again, in the context of the present invention, all incremental values therebetween for said thickness and or density values are included.

The cloth with a frothed polyurethane dispersion back-coating is next exposed to a heat source, such as an infrared oven, a convection oven or heating plates to dry the dispersion, evaporating any solvent or water present. The coated cloth may now be used in the “cut-and-sew”, “foam-in-place”, “vacuum form” and “shoot behind” (injection molding) downstream processes to prepare trim panels described herein.

Alternatively, the polyurethane dispersion may be applied to the backside of the cloth without frothing to provide a higher density, less permeable back coating. This then provides a more preferred cloth material for “shoot-behind”, high pressure molding procedures, such as injection molding.

### EXAMPLE I

In the present invention, a woven polyester cloth, Collins & Aikman's Dorchester 5012-3041, a velour having a weight of about 300 grams/square meter (12.6 ounces per square yard), was coated with an experimental polyurethane dispersion from the Dow Chemical Company, XNT 101.01 Experimental PU Dispersion. The dispersion was provided with polymer solids of about 52% and processed through an Oakes mixer to produce a froth having a density of about 0.11 grams/cubic centimeter (7 pounds per cubic foot). The frothed PUD was applied to the backside of the cloth and the cloth drawn under a doctor blade to yield a uniform combined froth and cloth layer about 6.4 mm (0.250 inches) in thickness. After drying for 8 minutes at 143 degrees C. (290 degrees F.) in a convection oven, the resultant foam-backed cloth was removed and cut to shape to form a trim cover for a seat cushion. The foam-backed cloth included a cured foam layer about 2.5 mm (0.100 inches thick).

Regarding the properties of the PUD backed cloth vs. a more traditional acrylic latex backed cloth, Table I shows a comparison of permeability (air flow) properties.

TABLE I

| | Sample A | Sample P |
|---|---|---|
| Permeability Air Flow, | 0 | 38 |
| ft³/min./ft² | | |
| (ASTM D 737-96) | | |

Samples of Spirit V6370-73BE cloth having a basis weight of about 288 grams/square meter (12.1 oz per square yard) were backed with either an acrylic latex layer and flame laminated to about 3.2 mm (0.125 inches) of polyurethane foam (Sample A) or with 3.2 mm (0.125 inches) of PUD using the process described above. When tested for Air Permeability per ASTM D 737-96, Sample A had 0 flow while the PUD backed cloth (Sample P) allowed an air flow of 38 cubic feet per minute per square foot. Air permeability of an absorptive substrate is known to have a direct correlation with sound absorption.

FIG. 3 demonstrates the improved acoustic performance of a PUD backed cloth in comparison to a cloth backed with acrylic latex and laminated foam. Both test specimens used the same cloth (Spirit V6370-73BE) and a foam layer (PUD or skived flexible urethane) of about 3.2 mm (0.125 inches) in thickness. The cloth backed with PUD (top line) provided a much higher absorption at nearly all the frequencies tested. The test method used was the Impedance Tube Method, ASTM E1050. Although not shown here, test data for cloth having only the acrylic latex applied provided very similar test data to the data shown for the cloth with acrylic latex and laminated foam.

It should be apparent from the above written description and Figures that by replacing acrylic latex as a cloth backing with a Polyurethane Dispersion, the resultant cloth may be used to form trim covers in upholstery applications and provide low cost, simplified downstream processing which does not require the subsequent step of laminating a foam to provide a cushioned trim cover.

In addition, the PUD backed cloth offers greater extensibility aiding in the formability of the cloth cover in the foam-in-place process and eliminates the need for a barrier film.

Further, it has been found that the PUID backed cloth provides enhanced properties in air permeability and acoustics.

The description and drawings illustratively set forth the presently preferred invention embodiment. We intend the description and drawings to describe this embodiment and not to limit the scope of the invention. Obviously, it is possible to modify these embodiments while remaining within the scope of the following claims. Therefore, within the scope of the claims one may practice the invention otherwise than as the description and drawings specifically shoe and describe.

1. A trim cover comprising a cloth including a backing layer, wherein said backing layer is a formed from a polyurethane dispersion.

2. The trim cover of claim 1, wherein the cloth is woven.

3. The trim cover of claim 1, wherein the cloth is a knit.

4. The trim cover of claim 1, wherein the polyurethane dispersion is in the form of a foam layer having a density in the range of 0.016 to 0.32 grams/cubic centimeter.

5. The trim cover of claim 1, wherein the backing layer is applied to a thickness of from about 2.6-51.3 mm.

6. A product covered with the trim cover of claim 1, said product being any one of a seat cushion, seat back, armrest, door panel, foot rest, instrument panel, air bag cover, headliner, parcel shelf, console cover, hassock, trim panel and panel insert.

7. The trim cover of claim 1 wherein said backing layer is of a thickness of about 0.26-51.3 mm.

8. The trim cover of claim 1 wherein said backing layer has a density of about 0.016-0.32 grams/cubic centimeter.

9. The trim cover of claim 1 wherein said trim cover is permeable.

10. The trim cover of claim 1 wherein said trim cover provides a sound absorption coefficient grater than 0.6 for frequencies greater than 400 Hz.

11. The trim cover of claim 1 wherein the cloth has a basis weight of between 100-950 grams/square meter.

12. A trim panel assembly comprising:
(a) a trim cover comprising a cloth including a backing layer, wherein said backing layer is a formed from a polyurethane dispersion;
(b) a molded plastic substrate supporting said trim cover.

13. The trim panel assembly of claim 12 wherein a layer of foam is positioned between said trim cover and said molded plastic substrate.

14. A method for forming a trim cover comprising:
a. supplying a cloth
b. applying a polyurethane dispersion as a backing layer to said cloth, wherein said polyurethane backing layer is applied and adhered to the cloth without the use of adhesives or flame lamination.

15. The method of claim 14 wherein said polyurethane backing layer is of a density of about 0.016-0.32 grams/cubic centimeter.

16. The method of claim 14 wherein said polyurethane dispersion comprises polyurethane in a liquid dispersion and said backing layer is applied and adhered by heating.

17. The method of claim 14 wherein said polyurethane backing is of a thickness of about 0.26-51.3 mm.

18. A method for forming a trim panel comprising:
a. supplying a cloth
b. applying a polyurethane dispersion as a backing layer to said cloth, wherein said polyurethane backing layer is applied and adhered to the cloth without the use of adhesives or flame lamination;
c. applying an molded plastic substrate without the use of a barrier film applied to said polyurethane back layer of said cloth.

19. The method of claim 18 wherein said step of applying a molded plastic substrate comprises injection molding.

20. The method of claim 18, including the step of applying a foam layer between said cloth and said molded plastic substrate.
